(19) United States
(12) Patent Application Publication
(10) Pub. No.: US 2025/0181284 A1
(43) Pub. Date: Jun. 5, 2025

(54) NON-TRANSITORY COMPUTER-READABLE RECORDING MEDIUM STORING COMPUTER-READABLE INSTRUCTIONS FOR TERMINAL DEVICE, TERMINAL DEVICE, AND METHOD FOR CONTROLLING TERMINAL DEVICE

(71) Applicant: BROTHER KOGYO KABUSHIKI KAISHA, Nagoya (JP)

(72) Inventor: Masayuki YATAGAI, Nagoya (JP)

(21) Appl. No.: 18/961,629

(22) Filed: Nov. 27, 2024

(30) Foreign Application Priority Data
Nov. 30, 2023 (JP) 2023-203027

(51) Int. Cl. G06F 3/12

(52) U.S. Cl. CPC G06F 3/1222; G06F 3/1204; G06F 3/1238; G06F 3/1288

(57) ABSTRACT

A terminal device may receive a subscription operation for subscribing to a service related to an image processing device, the image processing device being configured to communicate with the terminal device. The terminal device may, in a case where the subscription operation is received, acquire update information related to an update of an initial password. The terminal device may, in a case where the acquired update information is first update information, display on a display of the terminal device an instruction screen for instructing a user to execute an authentication operation on the image processing device. In a case where the acquired update information is second update information different from the first update information, displaying of the instruction screen may be limited.

### REFERENCE TO RELATED APPLICATIONS

This application claims priority to Japanese Patent Application No. 2023-203027 filed on Nov. 30, 2023. The entire content of the priority application is incorporated herein by reference.

### BACKGROUND ART

A print system including a mobile terminal device, a printer, and a server is known. When the printer receives a physical authentication from a user after the printer receives a physical authentication start notification is received from the mobile terminal device, the printer sends information that the physical authentication has been received to the mobile terminal device.

### SUMMARY

The present disclosure provides an art configured to improve convenience for a user convenience.

The present teachings disclose a non-transitory computer-readable recording medium storing computer-readable instructions for a terminal device comprising a processor. The computer-readable instructions, when executed by the processor, may cause the terminal device to: receive a subscription operation for subscribing to a service related to an image processing device, the image processing device being configured to communicate with the terminal device; in a case where the subscription operation is received, acquire update information related to an update of an initial password, the initial password being necessary to access the image processing device and being prestored in the image processing device; and in a case where the acquired update information is first update information, display on a display of the terminal device an instruction screen for instructing a user to execute an authentication operation on the image processing device, wherein in a case where the acquired update information is second update information different from the first update information, displaying of the instruction screen is limited.

According to the above configuration, the terminal device acquires the update information in the case where the terminal device receives the subscription operation, and the terminal device displays the instruction screen in the case where the update information is the first update information. Contrary to this, the terminal device restricts the displaying of the instruction screen in the case where the update information is the second update information. According to such configuration, the displaying of the instruction screen can be limited depending on the update information. Accordingly, user convenience can be improved.

A terminal device realized by the above-described computer-readable instructions, and a method for controlling the terminal device are also novel and useful. Also, a communication system including the terminal device and the image processing device is novel and useful.

### BRIEF DESCRIPTION OF DRAWINGS

FIG. 1 illustrates a configuration of a communication system.

FIG. 2 illustrates an example of screens displayed on a terminal device in a device selection process.

FIG. 3 illustrates a flowchart of a first image display process executed by the terminal device.

FIG. 4 illustrates a flowchart continued from FIG. 3.

FIG. 5 illustrates an example of an initial setup screen displayed on the terminal device.

FIG. 6 illustrates an example of a service screen displayed on the terminal device.

FIG. 7 illustrates an example of screens displayed on a printer in a second initial setup process.

FIG. 8 illustrates an example of screens displayed on the terminal device in a second password setting process.

FIG. 9 illustrates a flowchart of a second screen display process executed by the terminal device.

FIG. 10 illustrates an example of an instruction screen displayed on the terminal device.

FIG. 11 illustrates an example of a ‘process in execution’ screen displayed on the terminal device.

FIG. 12 illustrates a sequence diagram of Case A in which displaying of the instruction screen is limited.

FIG. 13 illustrates a sequence diagram of Case B in which the displaying of the instruction screen is not limited.

FIG. 14 illustrates a flowchart of a second screen display process executed by the terminal device in a second embodiment.

FIG. 15 illustrates an example of a program screen according to a second modification.

### DESCRIPTION

### First Embodiment

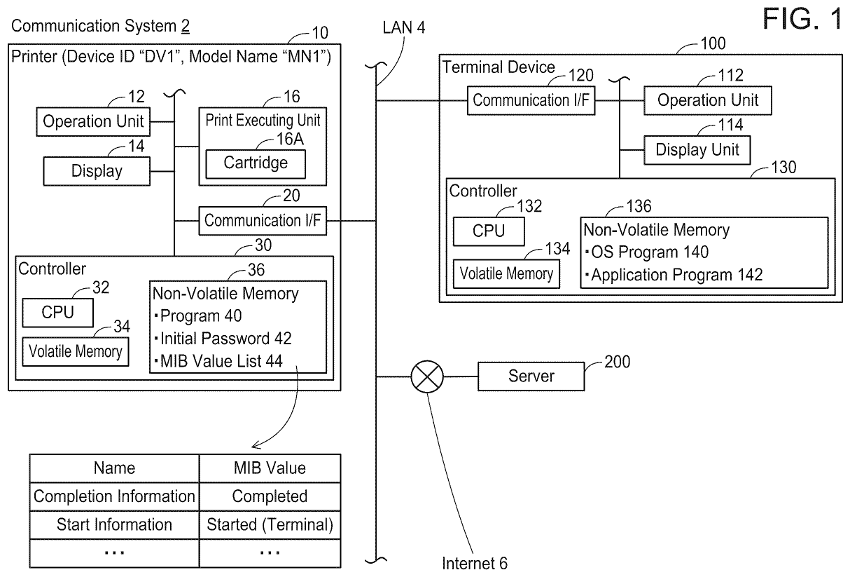

### Configuration of Communication System 2; FIG. 1

As illustrated in FIG. 1, a communication system 2 comprises a printer 10, a terminal device 100, and a server 200. The printer 10 and the terminal device 100 are connected to a Local Area Network (LAN) 4. The printer 10 and the terminal device 100 are configured to communicate with each other via the LAN 4. The printer 10, the terminal device 100, and the server 200 are connected to the Internet 6. The printer 10, the terminal device 100, and the server 200 are configured to communicate with each other via the Internet 6.

### Configuration of Printer 10

The printer 10 is a peripheral device configured to execute a print function. The printer 10 is further configured to execute a webserver function. The webserver function is a function of sending webpage data representing a webpage to an external apparatus in response to the external apparatus accessing a webserver in the printer 10. In a modification, the printer 10 may be a multi-function peripheral configured to execute a scan function, a facsimile function, and/or a copy function, for example, in addition to the print function and the webserver function. The printer 10 has a device ID “DV1” and a model name “MN1”. The device ID is a name assigned by an administer of the printer. The model name is a name indicating a model of the printer. The printer 10 comprises an operation unit 12, a display 14, a print executing unit 16, and a communication I/F 20.

The operation unit 12 is a user interface that allows the user to input various information to the printer 10. The operation unit 12 comprises a touch panel for displaying software key(s) (operation object(s)), hardware key(s), or a combination thereof. The hardware key(s) for example include button(s) and/or switch(es). The display 14 is a display or a panel for displaying various information. The panel may be or may not be a touch panel. The panel is for example an LCD panel or an organic EL panel.

The print executing unit 16 includes a print engine of inkjet scheme. The print engine of inkjet scheme includes a print head that ejects ink droplets. The print executing unit 16 is configured to have a cartridge 16A detachably mounted therein. The print executing unit 16 executes printing with ink in the cartridge 16A. In a modification, the print executing unit 16 may include a print engine of electrophotographic scheme or thermal scheme. The print engine of electrophotographic system includes a photoreceptor and an exposure device that exposes the photoreceptor by emitting light. The print engine of thermal scheme includes a print head that emits heat with a heater.

The communication I/F 20 is connected to the LAN 4. The communication I/F 20 may be a wired I/F or may be a wireless I/F.

A controller 30 comprises a CPU 32, a volatile memory 34, and a non-volatile memory 36. The volatile memory 34 includes a RAM and cache memory. The non-volatile memory 36 may be a ROM, a flash memory, a Solid State Drive (SSD), a Hard Disk Drive (HDD), or a combination thereof. The non-volatile memory 36 stores a program 40, an initial password 42, and a MIB value list 44 therein. The program 40 stored in the non-volatile memory 36 is loaded onto the volatile memory 34, and the program 40 is executed by the CPU 32, by which various types of processes are realized. The initial password 42 is prestored in the non-volatile memory 36 of the printer 10. Upon shipping of the printer, the initial password 42 is stored in the non-volatile memory 36. The initial password 42 is a password necessary for accessing the printer 10 and using the webserver function of the printer 10. The initial password 42 is written on a medium (e.g., instruction manual) enclosed in a package of the printer 10 and/or on a housing of the printer 10. In the present embodiment, the initial password 42 is a password “abcdef” including only alphabet. In a modification, the initial password 42 may be a password including only numbers, may be a password including a combination of alphabet and number(s), or may be a password including a combination of alphabet, number(s), and special character(s). For example, the initial password 42 may be a password “123456” including only numbers.

In the MIB value list 44, information related to a progress of an initial setup of the printer 10 is stored. The initial setup is an operation for allowing the user to use basic function(s) (e.g., print function) of the printer 10 after he/she purchases the printer 10. The initial setup includes an operation of attaching the cartridge onto the print executing unit 16 of the printer 10 and setting print paper in an accommodating part therefor of the printer 10 (not illustrated). That is, the initial setup includes mechanical operation(s) on the printer 10. In the MIB value list 44, a name and a MIB value are stored in association with each other. The name is a character string indicating a name of the information. The MIB value indicates a specific content of the information. A name “completion information” indicates information corresponding to whether the initial setup has been completed or not. A name “start information” indicates information corresponding to whether the initial setup has been started or not. The MIB value corresponding to the name “completion information” indicates either “Completed” indicating that the initial setup has been completed or “Not Completed” indicating that the initial setup has not been completed yet. The MIB value corresponding to the name “start information” indicates one of “Not Started” indicating that the initial setup has not been started yet, “Started (Device)” indicating that the initial setup has been started in response to operating the printer 10, and “Started (Terminal)” indicating that the initial setup has been started in response to operating a terminal device. Here, upon shipping, the MIB value corresponding to the name “completion information” and the MIB value corresponding to “start information” are respectively set as “Not Completed” and “Not Started”.

### Configuration of Terminal Device 100

The terminal device 100 is a terminal device such as a mobile phone (e.g., smartphone), a PDA, and a tablet PC. The terminal device 100 comprises an operation unit 112, a display 114, a communication I/F 120, and a controller 130.

The operation unit 112 is a user interface that allows the user to input various information to the terminal device 100. The operation unit 112 comprises, for example, a touch panel for displaying software key(s) (operational object(s)), hardware key(s), or a combination thereof. The hardware key(s) include, for example, button(s) and/or switch(es). The display 114 is a display or a panel for displaying the various information. The panel may be or may not be a touch panel. Also, the panel is for example an LCD panel or an organic EL panel. The communication I/F 120 is connected to the LAN 4.

The controller 130 comprises a CPU 132, a volatile memory 134, and a non-volatile memory 136. The non-volatile memory 136 stores an OS program 140 and an application program 142. Hereafter, the OS program 140 and the application program 142 will be denoted respectively “OS 140” and “app 142”. The OS 140 controls basic operations of the terminal device 100. The app 142 causes the printer 10, etc. to execute a print function. Respective processes to be described later are realized by the programs 140, 142 stored in the non-volatile memory 136 being loaded to the volatile memory 134 and the programs 140, 142 being executed by the CPU 132. Hereafter, the CPU 132 executing a process according to the app 142 may be referred to as the app 142 executing the process, for easier description.

### Configuration of Server 200

The server 200 is a server installed on the Internet 6 by a vendor of the printer 10 (hereafter, referred to as the “vendor” simply). The server 200 may be a single server or a combination of multiple servers.

The server 200 provides a subscription service related to a printer (hereafter, “subscription service”). The subscription service is a service for which a fee is charged. The subscription service charges a fixed fee if the number of sheets printed within a predetermined period (e.g., one month) is less than or equal to a contracted number of printed sheets (e.g., 1000 sheets), and charges a price acquired by totaling the fixed fee and a fee according to the printed number of sheets exceeding the contracted number of printed sheets if the number of printed sheets within the predetermined period exceeds the contracted number of printed sheets. The subscription service also includes an automatic ordering service of automatically ordering a new cartridge in a case where a remaining amount of ink in a cartridge mounted in the printer becomes a predetermined remaining amount or less. In a modification, the server 200 may provide a remote printing service.

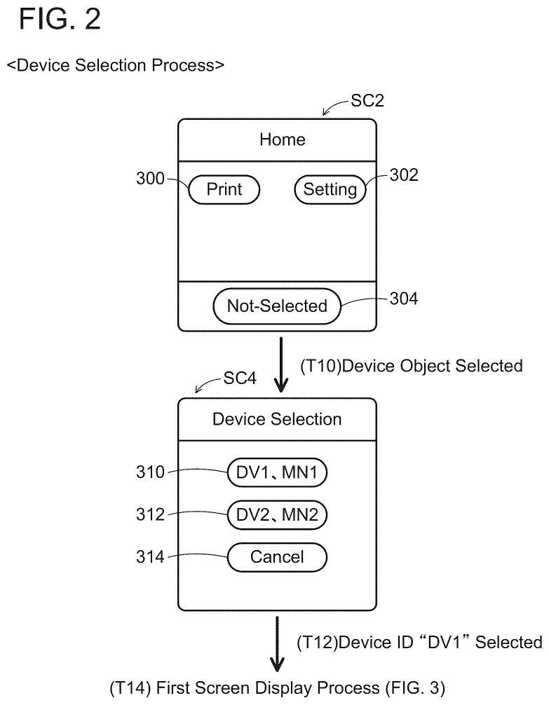

### Device Selection Process; FIG. 2

With reference to FIG. 2, a device selection process for selecting a printer to be registered in the app 142 will be described. All communication executed between the terminal device 100 and another device (printer 10 and server 200) is executed via the communication I/F 120 of the terminal device 100. Accordingly, hereafter, a description “via the communication I/F 120” will be omitted. Likewise, the app 142 executes respective processes by accessing each hardware such as the display 114, the volatile memory 134, the non-volatile memory 136, and the communication I/F 120 via the OS 136. Hereafter, the recitation that the app 142 executes a process via the OS 140 may be omitted in some parts of the description.

Firstly, a user of the terminal device 100 performs an operation for activating the app 142 (hereafter “app activating operation”) on the terminal device 100. Due to this, the app 142 of the terminal device 100 displays a home screen SC2 on the display 114. The home screen SC2 includes a Print button 300, a Setting button 302, and a device object 304. The device object 304 is an object indicating information related to printer(s) registered in the app 142. The device object 304 functions also as a button for searching for printer(s) registered in the app 142. When no printer is registered in the app 142, a character string “Not Selected” is displayed in the device object 304. Contrary to this, when one or more printers are registered in the app 142, a device ID, a model name, etc. of each printer are displayed in the device object 304.

In T10, the user performs an operation on the device object 304 on the home screen SC2. Due to this, the app 142 executes a search process for searching for device(s) belonging to the LAN 4, and displays a device selection screen SC4 on the display 114. In the search process, the app 142 receives a response signal including the device ID and the model name from each of the device(s) belonging to the LAN 4 in response to sending a search signal for searching for device(s) belonging to the LAN 4. The app 142 displays the device selection screen SC4 on the display 114 by using the received response signal. The device selection screen SC4 includes device buttons 310, 312 corresponding to the received response signal and a Cancel button 314. The device buttons 310, 312 are buttons for selecting a printer registered in the app 142. The device button 310 is a button corresponding to the printer 10. The device button 312 is a button corresponding to a printer (not illustrated) having a device ID “DV2” and a model name “MN2”.

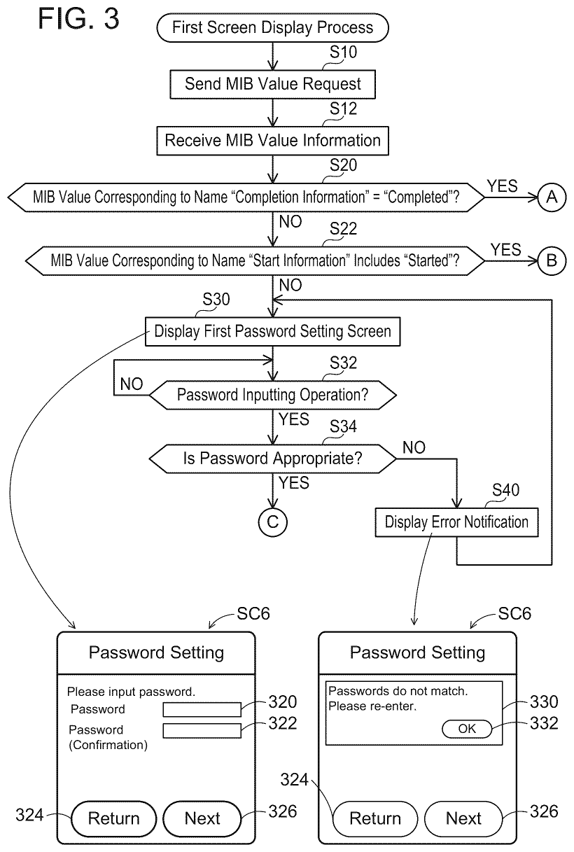

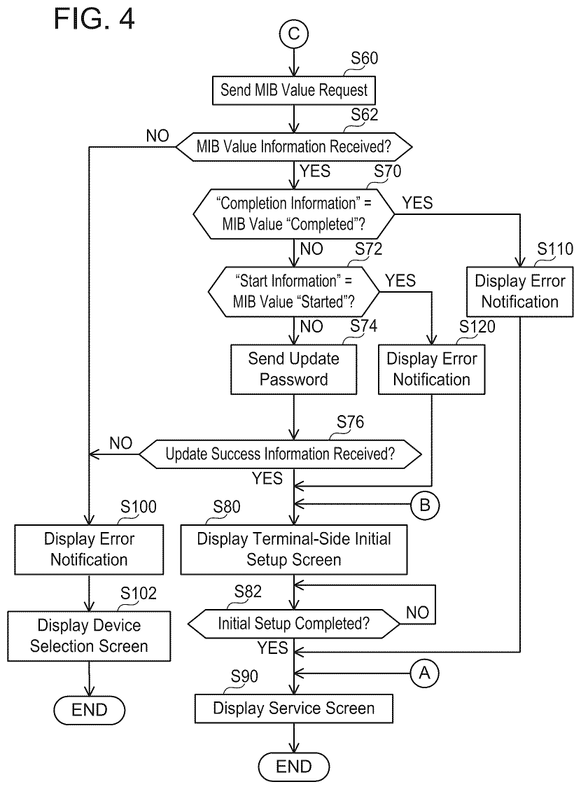

In T12, the user performs an operation on the device button 310 on the device selection screen SC4. Due to this, the app 142 executes a first screen display process (see FIGS. 3 and 4).

### First Screen Display Process; FIGS. 3, 4

With reference to FIGS. 3 and 4, the first screen display process executed by the app 142 of the terminal device 100 will be described. As described above, the app 142 executes the first screen display process of FIGS. 3, 4 when one of the device buttons on the device selection screen SC4 is selected.

In S10, the app 142 sends a MIB value request to the printer corresponding to the printer selected on the device selection screen SC4. Hereafter, a case where the device button 310 is selected on the device selection screen SC4 will be described as an example. In this case, the app 142 sends the MIB value request to the printer 10. The MIB value request is a signal for requesting for sending of MIB values respectively corresponding to the names “completion information” and “start information”.

In S12, the app 142 receives the MIB value information from the printer 10. The MIB value information includes the MIB values respectively corresponding to the names “completion information” and “start information”.

In S20, the app 142 determines whether the MIB value corresponding to the name “completion information” is “Completed” or not. In a case where the MIB value is “Completed” (YES to S20), the app 142 proceeds to S90 in FIG. 4. Contrary to this, in a case where the MIB value is not “Completed” (NO to S20), the app 142 proceeds to S22.

In S22, the app 142 determines whether the MIB value corresponding to the name “start information” includes “Started” or not. In a case where the MIB value includes “Started” (YES to S22), the app 142 proceeds to S80 in FIG. 4. Contrary to this, in a case where the MIB value does not include “Started” (NO to S22), the app 142 proceeds to S30. Here, a case where YES is determined to S22 is a case where the initial setup of the printer 10 has been started but not completed yet.

In S30, the app 142 displays a first password setting screen SC6 on the display 114. The first password setting screen SC6 includes an update password input area 320, a confirmation password input area 322, a Return button 324, and a Next button 326. The update password input area 320 is an area for inputting an update password which is to replace the initial password 42 necessary for accessing the printer 10. The confirmation password input area 322 is an area for inputting a password for confirmation.

In S32, the app 142 monitors for receiving a password inputting operation. The password inputting operation includes an operation for inputting a password respectively to the update password input area 320 and the confirmation password input area 322 and an operation for selecting the Next button 326. In a case where the app 142 receives the password inputting operation, the app 142 determines YES to S32, and proceeds to S34.

In S34, the app 142 determines whether the inputted password is appropriate or not. In a case where the inputted password is appropriate (YES to S34), the app 142 proceeds to S60 in FIG. 4. Contrary to this, in a case where the inputted password is not appropriate (NO to S34), the app 142 proceeds to S40. Specifically, the app 142 determines whether the password inputted to the update password input area 320 (hereafter, “update password”) and the password inputted to the confirmation password input area 322 (hereafter, “confirmation password”) match or not. In a case where the update password and the confirmation password do not match, the app 142 determines that the inputted password is not appropriate (NO to S34). Contrary to this, in a case where the update password and the confirmation password match, the app 142 determines whether the update password satisfies a predetermined password condition or not. Although this is merely an example, the predetermined password condition is that there are no three consecutive same letters (e.g., “a”). In a case where the update password satisfies the predetermined password condition, the app 142 determines that the inputted password is appropriate (YES to S34). Contrary to this, in a case where the update password does not satisfy the predetermined password condition, the app 142 determines that the inputted password is not appropriate (NO to S34).

In S40, the app 142 displays an error notification 330 on the first password setting screen SC6. The error notification includes a message indicating a reason why the inputted password is not appropriate, a message prompting to re-enter a password, and an OK button 332. The error notification displayed in the case where the update password and the confirmation password do not match includes a message “Passwords do not match”. Also, the error notification displayed in the case where the update password does not satisfy the predetermined password condition includes a message “Password does not satisfy predetermined password condition.” When the app 142 receives an operation on the OK button 332 on the error notification 330, the app 142 returns to S30.

S60, S62, S70, and S72 in FIG. 4 are the same as S10, S12, S20, and S22 in FIG. 3. In the case where YES is determined to S62, the app 142 proceeds to S70, whereas in the case where NO is determined to S62, the app 142 proceeds to S100. The case where NO is determined to S62 is a case where communication becomes impossible between the terminal device 100 and the printer 10 after S12 in FIG. 3. In the case where YES is determined to S70, the app 142 proceeds to S110, and in the case where NO is determined to S70, the app 142 proceeds to S72. In the case where YES is determined to S72, the app 142 proceeds to S120 whereas in the case where NO is determined to S72, the app 142 proceeds to S74.

In S74, the app 142 sends the update password to the printer 10. When the printer 10 receives the update password from the terminal device 100, the printer 10 stores the update password as a password with which the initial password 42 is replaced in the non-volatile memory 36. In this case, in a case where an operation related to the initial setup process is performed, the printer 10 stores “Started (Terminal)” as the MIB value corresponding to the name “start information” in the MIB value list 44. Then, the printer 10 sends update success information indicating that the update password has been stored in the printer 10 to the terminal device 100. Hereafter, a status that the update password is stored as a password with which the initial password 42 is replaced in the non-volatile memory 36 may be described as “the initial password 42 has been updated.”

In S76, the app 142 determines whether the update success information has been received from the printer 10 or not. In a case where the app 142 receives the update success information from the printer 10 (YES to S76), the app 142 stores the update password in the volatile memory 134, and proceeds to S80. Contrary to this, in a case where the app 142 does not receive the update success information from the printer 10 (NO to S76), the app 142 proceeds to S100. Here, the case where NO is determined to S76 is a case where communication becomes impossible between the terminal device 100 and the printer 10 after S62. Hereafter, a process that the update password with which the initial password 42 is replaced is stored in the non-volatile memory 36 of the printer 10 in response to the update password being inputted into the first password setting screen SC6 will be described as “first password setting process”.

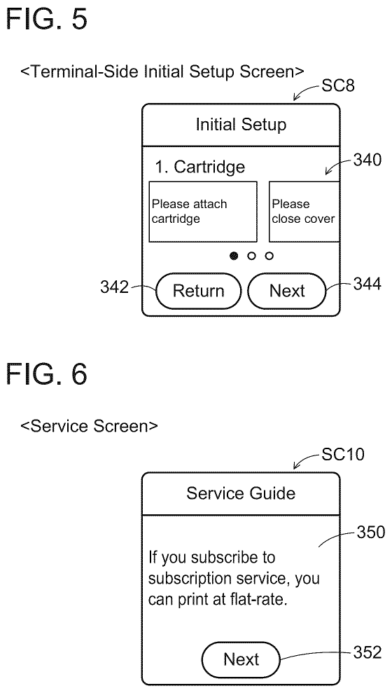

In S80, the app 142 displays a terminal-side initial setup screen SC8 related to the initial setup on the display 114. As illustrated in FIG. 5, the terminal-side initial setup screen SC8 includes a setup introduction area 340, a Return button 342, and a Next button 344. The setup introduction area 340 is an area which introduces an operation the user should perform. The user can change the information displayed on the terminal-side initial setup screen SC8 by performing an operation of sliding the setup introduction area 340 laterally. In response to the user performing an operation which conforms to the information in the setup introduction area 340, the printer 10 executes the initial setup process, and thus the initial setup of the printer 10 is completed. The initial setup process includes a process of detecting a mechanical operation the user should perform for the initial setup and filling the print head of the print executing unit 16 with ink. Here, the mechanical operation the user should perform for the initial setup is, for example, attaching the cartridge in/to the print executing unit 16 of the printer 10. Further, when the initial setup is completed, the printer 10 stores “Completed” as the MIB value corresponding to the name “completion information” in the MIB value list 44. Hereafter, the process executed in accordance with the terminal-side initial setup screen SC8 will be described as “first initial setup process”.

In S82 of FIG. 4, the app 142 monitors for the initial setup of the printer 10 being completed. Specifically, the app 142 sends an inquiry signal for inquiring of whether the initial setup has been completed or not to the printer 10 when an operation on a Next button 334 on the terminal-side initial setup screen SC8 is received. When the printer 10 receives the inquiry signal from the terminal device 100 with the initial setup completed, the printer 10 sends completion information indicating that the initial setup has been completed to the terminal device 100. Contrary to this, when the printer 10 receives the inquiry signal from the terminal device 100 with the initial setup not completed, the printer 10 sends non-completion information indicating that the initial setup is not completed yet to the terminal device 100. The non-completion information includes information indicating operation(s) which are not performed among operations included in the initial setup. In a case where the app 142 receives the completion information from the printer 10, the app 142 determines YES to S82 and proceeds to S90.

As mentioned above, in a case where NO to S20 in FIG. 3 and YES to S22 in FIG. 3 are determined, the app 142 displays the terminal-side initial setup screen SC8 on the display 114. In the case where NO to S20 in FIG. 3 and YES to S22 in FIG. 3 are determined, the initial setup has been started by another user. It is not appropriate to display the first password setting screen SC6 on the display 114 in such situation. Further, it is useful for the user to display the terminal-side initial setup screen SC8 on the display 114. Accordingly, user convenience can be improved.

In a case where the app 142 receives the update success information from the printer 10, the app 142 displays the terminal-side initial setup screen SC8 on the display 114. It is necessary to execute the initial setup in order to use basic operations of the printer 10 after the initial password 42 has been updated. Accordingly, useful information for the user can be displayed on the display 114.

In S90, the app 142 displays a service screen SC10 (see FIG. 6) on the display 114. As illustrated in FIG. 6, the service screen SC10 includes a service message 350 and a Next button 352. The service message 350 indicates a content of the subscription service. Although this is merely an example, the service message 350 is “If you subscribe to subscription service, you can print at flat-rate.”

As mentioned above, in the case where YES is determined to S20 in FIG. 3, the first password setting screen SC6 and the terminal-side initial setup screen SC8 are not displayed on the display 114. In the case where YES is determined to S20 in FIG. 3, the initial setup is already completed. It is not appropriate to display the first password setting screen SC6 on the display 114 in such situation. Further, the information related to the terminal-side initial setup screen SC8 is not useful for the user. Accordingly, a screen which is not useful for the user can be suppressed from being displayed on the display 114.

Also, in a case where NO to S62 in FIG. 4 or NO to S76 in FIG. 4 are determined, in S100, the app 142 displays an error notification on the first password setting screen SC6 (see FIG. 3). The error notification in this case includes a message indicating that the initial password 42 of the printer 10 cannot be updated.

In S102, the app 142 executes the search process, and displays a device selection screen on the display 114. When S102 ends, the app 142 ends the processes of FIG. 4.

In S110 after YES to S70, the app 142 displays an error notification on the first password setting screen SC6 (see FIG. 3). The error notification in this case includes a message indicating that the initial password 42 of the printer 10 cannot be updated. According to such configuration, the user can be aware that he/she failed to update the initial password. When S110 ends, the app 142 proceeds to S90. That is, the app 142 displays the service screen SC10 (see FIG. 6) on the display 114 without displaying the terminal-side initial setup screen SC8 (see FIG. 5) on the display 114. With the initial setup completed, the information related to the terminal-side initial setup screen SC8 is not useful for the user. Accordingly, a screen which is not useful for the user can be suppressed from being displayed on the display 114.

Also, in S120 after YES to S72, the app 142 displays an error notification on the first password setting screen SC6 (see FIG. 3). The error notification in this case includes a message indicating that the initial password 42 of the printer 10 cannot be updated. According to such configuration, the user can be aware that he/she failed to update the initial password. When S120 ends, the app 142 proceeds to S80. That is, the app 142 displays the terminal-side initial setup screen SC8 (see FIG. 5) on the display 114. In a case where NO to S70 and YES to S72 are determined, the initial setup is not completed yet. In this case, the information included in the terminal-side initial setup screen SC8 is useful for the user. Accordingly, user convenience can be improved.

As mentioned above, in the case where the initial setup is not started yet (NO to S22 in FIG. 3), the app 142 displays the first password setting screen SC6 on the display 114. It is desirable that the initial password 42 of the printer 10 be updated by a user who can execute the initial setup of the printer 10. According to the above configuration, it is possible to have the user who can execute the initial setup of the printer 10 update the initial password 42 of the printer 10.

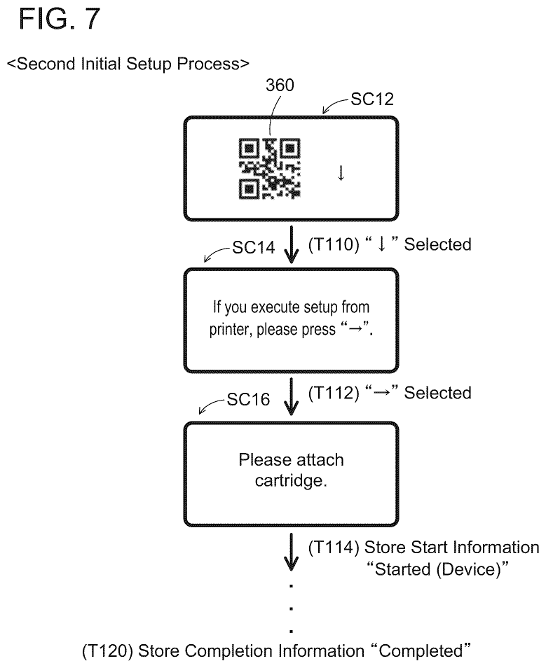

### Second Initial Setup Process; FIG. 7

With reference to FIG. 7, a second initial setup process different from the first initial setup process will be described. The second initial setup process is an initial setup executed in accordance with a screen displayed on the display 14 of the printer 10.

In a case where the MIB value corresponding to the name “completion information” is “Not Completed”, the printer 10 displays a first initial screen SC12 on the display 14. That is, when power of the printer 10 is turned on for the first time, the printer 10 displays the first initial screen SC12 on the display 14. The first initial screen SC12 includes a QR Code 360 and “↓” (downward arrow). “QR Code” is a registered trademark of DENSO WAVE INCORPORATED. The QR Code 360 is information for accessing the terminal-side initial setup screen SC8 (see FIG. 5).

In T110, the user operates “↓” on the operation unit 12. Due to this, the printer 10 displays a second initial screen SC14. The second initial screen SC14 includes a message indicating a content of an operation for starting the initial setup.

In T112, the user operates “→” (rightward arrow) on the operation unit 12. Due to this, the printer 10 displays a printer-side initial setup screen SC16 on the display 14. The printer-side initial setup screen SC16 includes a content of an operation the user should perform. Although this is merely an example, the printer-side initial setup screen SC16 includes a message “Please attach cartridge.” Also, in T114, the printer 10 stores “Started (Device)” as the MIB value corresponding to the name “start information” in the MIB value list 44.

In response to the user performing an operation which conforms to the content displayed on the printer-side initial setup screen SC16, the printer 10 executes the initial setup process, and thus the initial setup of the printer 10 is completed. As such, the second initial setup process is completed. In this case, in T120, the printer 10 stores “Completed” as the MIB value corresponding to the name “completion information” in the MIB value list 44. As such, the password setting screen for setting the update password is not displayed prior to execution of the second initial setup process. Due to this, the initial password 42 of the printer 10 is not updated after the execution of the second initial setup process.

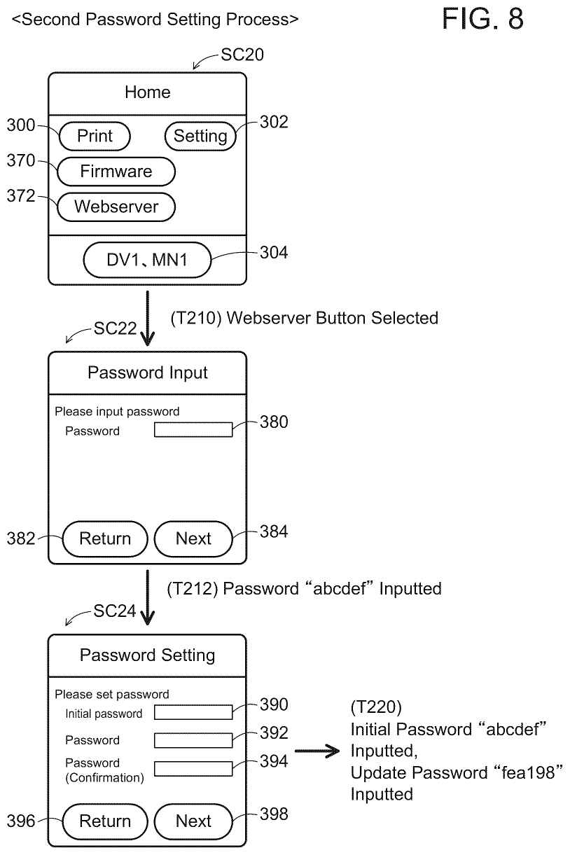

### Second Password Setting Process; FIG. 8

With reference to FIG. 8, a second password setting process different from the first password setting process will be described. The second password setting process is a process for updating the initial password 42 of the printer 10 after the initial setup of the printer 10 has been completed. The second password setting process is executed after the second initial setup process in FIG. 7 has been executed. Here, at an initial state of FIG. 8, the printer 10 is registered in the app 142.

Firstly, the user of the terminal device 100 performs an app activating operation on the terminal device 100. Due to this, the app 142 of the terminal device 100 displays a home screen SC20 on the display 114. The home screen SC20 includes a Print button 300, a Setting button 302, a Firmware button 370, a Webserver button 372, and a device object 304. In the device object 304, the device ID “DV1” and the model name “MN1” of the printer 10 are displayed. The Firmware button 370 is a button for accessing the printer 10 to update a firmware installed on the printer 10. The Webserver button 372 is a button for accessing the printer 10 to use the webserver function of the printer 10.

In T210, the user performs an operation on the Webserver button 372 on the home screen SC20. Due to this, the app 142 sends a webserver screen data request to the printer 10. When the printer 10 receives the webserver screen data request from the terminal device 100, the printer 10 sends password inputting screen data to the terminal device 100. When the app 142 receives the password inputting screen data from the printer 10, the app 142 displays a password inputting screen SC22 represented by the password inputting screen data on the display 14. The password inputting screen SC22 includes a password input area 380, a Return button 382, and a Next button 384.

In T212, the user performs an operation of inputting a password “abcdef” (i.e., initial password) in the password input area 380 and an operation on the Next button 384. Due to this, the app 142 sends the password “abcdef” to the printer 10. When the printer 10 receives the password “abcdef” from the terminal device 100, the printer 10 determines that the received password “abcdef” matches the initial password 42, and sends password setting screen data to the terminal device 100. When the app 142 receives the password setting screen data from the printer 10, the app 142 displays a second password setting screen SC24 represented by the password setting screen data. The second password setting screen SC24 includes an initial password input area 390, an update password input area 392, a confirmation password input area 394, a Return button 396, and a Next button 398. The initial password input area 390 is an area for inputting an initial password. As such, the second password setting screen SC24 differs from the first password setting screen SC6 (see FIG. 3) in that the second password setting screen SC24 includes the initial password input area 390.

In T220, the user performs an operation of inputting the password “abcdef” into the initial password input area 390 and an operation of inputting the update password “fea198” into each of the update password input area 392 and the confirmation password input area 394. Due to this, in T220, the app 142 sends the initial password “abcdef” and the update password “fea198” to the printer 10. When the printer 10 receives the initial password “abcdef” and the update password “fea198” from the terminal device 100, the printer 10 determines that the received initial password “abcdef” matches the initial password 42, the printer 10 stores the update password “fea198” in the non-volatile memory 36 as a password with which the initial password 42 is replaced and necessary for accessing the printer 10. Subsequently, the printer 10 sends webserver screen data representing a webserver screen (not illustrated) for using the webserver function to the terminal device 100. As such, the second password setting process is completed. Although the update password mentioned above is a password including a combination of alphabet and numbers, the update password may be a password including only numbers, may be a password including only alphabet, and may be a password including a combination of alphabet, number(s), and special character(s).

### Second Screen Display Process

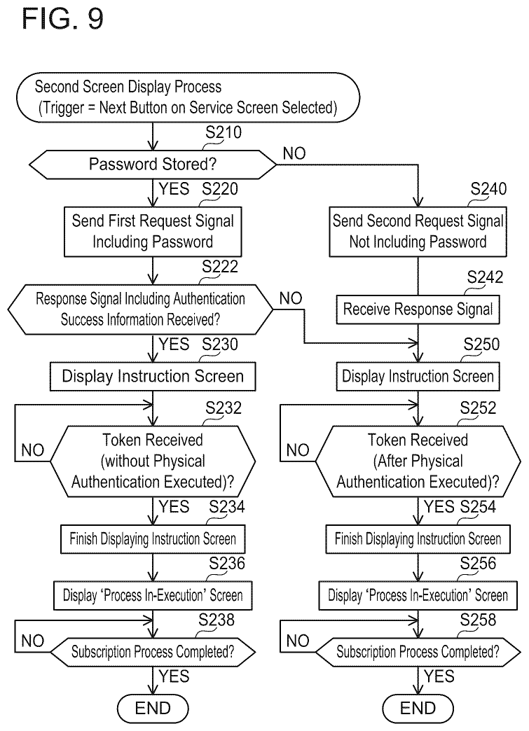

With reference to FIG. 9, a second screen display process executed by the app 142 of the terminal device 100 will be described. The app 142 starts processes of FIG. 9 in response to receiving an operation of selecting the Next button 352 (see FIG. 6) on the service screen SC10.

In S210, the app 142 determines whether a password necessary for accessing the printer 10 is stored in the volatile memory 134 or not. In a case where the password is stored in the volatile memory 134 (YES to S210), the app 142 proceeds to S220. Contrary to this, in a case where the password is not stored in the volatile memory 134 (NO to S210), the app 142 proceeds to S240. Here, the case where YES is determined to S210 is when the update password that was stored in the volatile memory 134 in response to YES being determined to S76 in FIG. 4 remains in the volatile memory 134.

In S220, the app 142 acquires the password stored in the volatile memory 134, and sends a first request signal including the acquired password to the printer 10. The password sent from the app 142 to the printer 10 in S220 is the update password that was stored in the volatile memory 134 in response to YES being determined to S76 in FIG. 4. Here, the password included in the first request signal may be encrypted or encoded by the app 142. When the printer 10 receives the first request signal from the terminal device 100, the printer 10 determines whether a password with which the initial password 42 is replaced is stored in the printer 10 or not. In a case where the password with which the initial password is replaced is not stored in the printer 10, the printer 10 sends a response signal including failure information to the terminal device 100. Contrary to this, in a case where the password with which the initial password is replaced is stored in the printer 10, the printer 10 further determines whether the password received from the terminal device 100 and the password with which the initial password is replaced match or not. In a case where the two passwords match, the printer 10 determines that authentication has succeeded, and sends a response signal including authentication success information to the terminal device 100. Contrary to this, in a case where the two passwords do not match, the printer 10 determines that the authentication has failed, and sends a response signal including the failure information to the terminal device 100.

In S222, the app 142 determines whether the app 142 has received the response signal including the authentication success information from the printer 10. In a case where the app 142 receives the response signal including the authentication success information from the printer 10 (YES to S222), the app 142 proceeds to S230. Contrary to this, in a case where the app 142 does not receive the response signal including the authentication success information from the printer 10 (NO to S222), the app 142 proceeds to S250. According to such configuration, the app 142 can suitably determine whether the password stored in the volatile memory 134 is stored in the printer 10 as a password with which the initial password is replaced. That is, it is possible to suitably determine whether the initial password 42 was updated by the user of the terminal device 100.

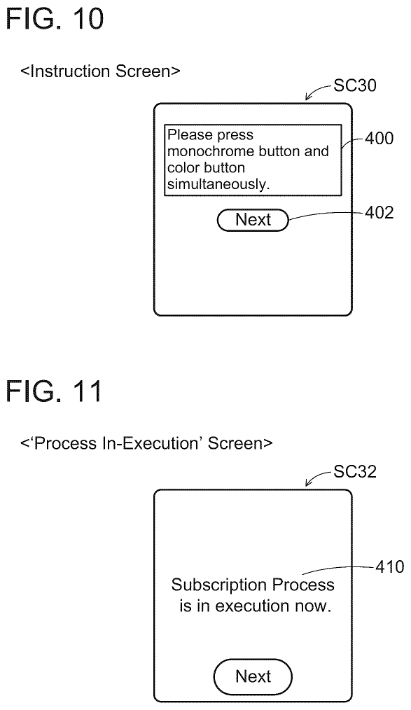

In S230, the app 142 displays an instruction screen SC30 (see FIG. 10) for instructing the user to execute physical authentication on the display 114. The physical authentication is an authentication operation for authenticating a user, and is a physical operation on the printer 10. The physical operation here includes an operation of the hardware key(s), operation of software key(s) (operation object(s) displayed on the touch panel), or a combination thereof. The printer 10 executes authentication of the user in response to such physical operation being performed. The authentication can be regarded as authentication for assuring that the user is near the printer 10. In the present embodiment, the physical authentication is an operation required for the user to subscribe to the subscription service for the first time. As illustrated in FIG. 10, the instruction screen SC30 includes a prompt message 400 for instructing the user to perform the physical authentication and a Next button 402. Although this is an example, the prompt message 400 is “Please press monochrome button and color button simultaneously.” Due to this, the user can acknowledge the content of the physical authentication and that the physical authentication needs to be performed. Here, after the app 142 has displayed the instruction screen SC30 on the display 114, the app 142 periodically sends a token request for requesting the printer 10 to send a token to the printer 10. The token is authentication information for being used for communication between the printer 10 and the terminal device 100. In the case where YES has been determined to S222, the authentication using the password sent from the terminal device 100 to the printer 10 has already succeeded in the printer 10. In this case, the printer 10 generates a token without receiving the physical authentication being performed, and in a case where the printer 10 receives the token request from the terminal device 100, the printer 10 sends the generated token to the terminal device 100.

In S232, the app 142 monitors receipt of the token from the printer 10. In a case where the app 142 receives the token from the printer 10, the app 142 determines YES to S232, and proceeds to S234.

In S234, the app 142 stops displaying the instruction screen SC30 (see FIG. 10).

In S236, the app 142 displays a ‘process in-execution’ screen SC32 (see FIG. 11) on the display 114. That is, the app 142 displays the ‘process in-execution’ screen SC32 on the display 114 instead of the instruction screen SC30. As illustrated in FIG. 11, the ‘process in-execution’ screen SC32 includes a message 410 (e.g., “Subscription Process is in execution now.”) indicating that the subscription process is in execution. The subscription process is for subscribing to the subscription service. The subscription process is executed between the printer 10, the terminal device 100, and the server 200. The subscription process includes an establishing process, a device registration process, and payment information registration process, for example. The establishing process is a process for establishing fulltime connection between the printer 10 and the server 200. The fulltime connection is for example an Extensible Messaging and Presence Protocol (XMPP) connection. The device registration process is a process for registering the device ID “DV1” of the printer 10 in the server 200. In response to the device ID “DV1” being sent from the printer 10 to the server 200, the device ID “DV1” is registered in the server 200. The payment information registration process is a process for registering information for paying a print fee. In the subscription process, a plurality of pieces of screen data (webpages) is sent from the server 200 to the terminal device 100. The terminal device 100 displays the screen data received from the server 200 on the display 114, by using a web view function.

In S238, the app 142 monitors for the subscription process being completed. For example, in a case where the app 142 receives a notification indicating that the subscription process has completed from the server 200, the app 142 determines that the subscription process has completed. In a case where the app 142 determines that the subscription process has completed, the app 142 determines YES to S238 and ends the processes of FIG. 9. Here, in a case where the service screen SC10 displayed on the display 114 is a screen corresponding to S90 in FIG. 4 before the app 142 starts the processes of FIG. 9, the app 142 stores the device ID “DV1” and the model name “MN1” of the printer 10 selected in the device selection screen SC4 (see FIG. 2) in the non-volatile memory 136. Due to this, the registration of the printer 10 in the app 142 is completed.

Also, in a case where NO is determined to S210, in S240, the app 142 sends a second request signal which does not include a password to the printer 10. When the printer 10 receives the second request signal from the terminal device 100, the printer 10 sends a response signal which does not include the failure information nor the authentication success information to the terminal device 100.

In S242, the app 142 receives the response signal from the printer 10.

S250 is the same as S230. Here, in the case where NO to S210 or NO to S220 was determined, in the printer 10, the authentication has not succeeded yet. In this case, the printer 10 generates a token after receiving the physical authentication being performed by the user. That is, the printer 10 generates the token only in the case where the printer 10 receives the physical authentication being performed by the user.

In S252, the app 142 monitors receipt of the token from the printer 10. In the case where the app 142 receives the token from the printer 10, in S252, the app 142 determines YES and proceeds to S254.

In S254, the app 142 stops displaying the instruction screen SC30 (see FIG. 10). As mentioned above, in the case where NO to S210 or S220 to NO was determined, the printer 10 generates the token only when the printer 10 receives the physical authentication being performed by the user. Contrary to this, in the case where YES was determined to S210, the printer 10 generates the token without receiving the execution of the physical authentication by the user. Due to this, after YES was determined to S222, a time required for the app 142 to receive the token from the printer 10 after the instruction screen SC30 has been displayed is shorter than a time for the app 142 to receive the token from the printer 10 in the case where NO to S210 or NO to S220 was determined. That is, the displaying of the instruction screen SC30 can be regarded as being limited after YES was determined to S222 as compared to after NO to S210 or NO to S220 was determined.

S256 and S258 are respectively the same as S236 and S238.

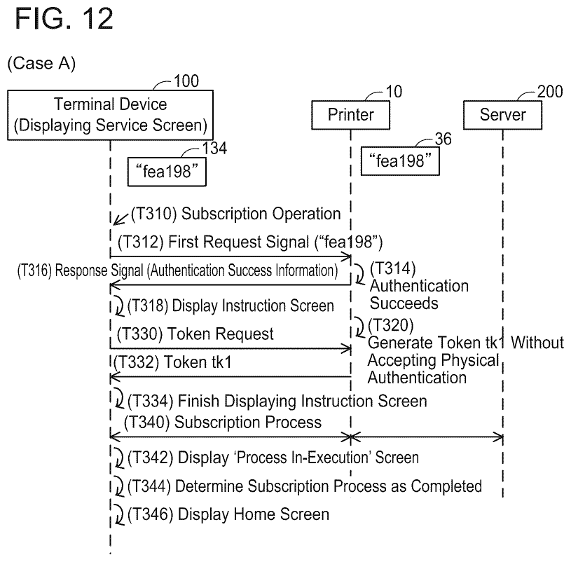

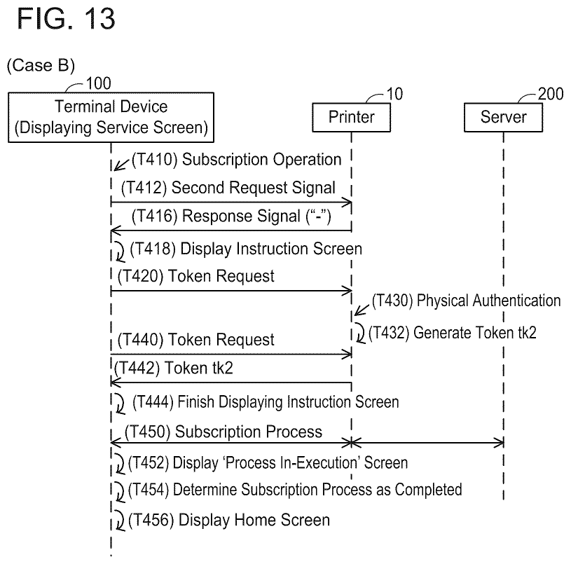

### Specific Cases; FIGS. 12 and 13

With reference to FIGS. 12 and 13, specific cases realized by the communication system 2 of the present embodiment will be described.

### Case A; FIG. 12

With reference to FIG. 12, Case A in which the displaying of the instruction screen SC30 (see FIG. 10) is limited will be described. Case A is a state where the initial password 42 of the printer 10 is updated in response to the password “fea198” being inputted to the first password setting screen SC6 (see FIG. 3), and thereafter the first initial setup process is completed. Due to this, the password “fea198” is stored in the volatile memory 134 of the terminal device 100. Also, the password “fea198” is stored in the non-volatile memory 36 of the printer 10. Further, the service screen SC10 (see FIG. 6) is displayed on the display 114 of the terminal device 100. Hereafter, the contents of respective processes will be described with each device (e.g., the printer 10) as a subject of action, instead of describing the CPU of each device (e.g., the CPU 32) as the subject of action.

In T310, the user performs the subscription process. In this case, the terminal device 100 determines that the password “fea198” is stored in the volatile memory 134 (YES to S210 in FIG. 9), acquires the password “fea198” in the volatile memory 134, and in T312 sends the first request signal including the password “fea198” to the printer 10 (S220).

In T312, when the printer 10 receives the first request signal from the terminal device 100, in T314 the printer 10 determines that the authentication has succeeded because the password “fea198” in this signal and the password “fea198” in the non-volatile memory 36 of the printer 10 match. In this case, in T316 the printer 10 sends the response signal including the authentication success information to the terminal device 100.

When the terminal device 100 receives the response signal from the printer 10 in T316, the terminal device 100 determines that the response signal including the authentication success information has been received (YES to S222), and in T318 the terminal device 100 displays the instruction screen SC30 (see FIG. 10) (S230).

Since the authentication has succeeded, in T320 the printer 10 generates a token tk1 without receiving the physical authentication being performed by the user.

In T330 after displaying the instruction screen SC30, the terminal device 100 sends a token request to the printer 10, in T332 the terminal device 100 receives the token tk1 from the printer 10 (YES to S232), and in T334 the terminal device 100 stops displaying the instruction screen SC30 (S234). The terminal device 100 receives the token tk1 from the printer 10 relatively soon after displaying the instruction screen SC30. Due to this, the terminal device 100 displays the instruction screen SC30 for a short amount of time only.

Thereafter, in T340, the subscription process is executed between the printer 10, the terminal device 100, and the server 200. Further, in T342 the terminal device 100 displays the ‘process in-execution’ screen SC32 (see FIG. 11) (S236). Subsequently, in T344, the terminal device 100 determines that the subreption process has ended (YES to S238) and in T346 the terminal device 100 displays a home screen. As such, subscription to the subscription service by the user is completed.

### Effects of Case A

In the case where the terminal device 100 receives the response signal including the authentication success information from the printer 10, the initial setup of the printer 10 has been completed by the user of the terminal device 100. That is, the user has already performed an operation on the printer 10. If the user is made to perform the physical authentication in such situation, the user may feel a burden about doing so. According to the above configuration, since the displaying of the instruction screen SC30 is limited, the user can be suppressed from feeling a burden.

The password “fea198” is stored in the volatile memory 134 of the terminal device 100. According to such configuration, the password “fea198” in the volatile memory 134 is deleted in response to the app 142 being finished. Accordingly, as compared to when the password “fea198” is stored in the non-volatile memory 136 of the terminal device 100, security for the password “fea198” can be improved.

### Case B; FIG. 13

With reference to FIG. 13, Case B in which the displaying of the instruction screen SC30 (see FIG. 10) is not limited will be described. Case B is a state after the second initial setup process of FIG. 7 has completed. As such, no password is stored in the volatile memory 134 of the terminal device 100. Also, no password with which the initial password 42 is replaced is stored in the non-volatile memory 36 of the printer 10. Further, the service screen SC10 (see FIG. 6) is displayed on the display 114 of the terminal device 100.

In T410, the user performs the subscription process. In this case, the terminal device 100 determines that no password is stored in the volatile memory 134 (NO to S210 in FIG. 9), in T412 the terminal device 100 sends the second request signal which does not include a password to the printer 10 (S240), and in T416 the terminal device 100 receives the response signal which does not include the failure information nor the authentication success information from the printer 10 (S242). T418 is the same as T318.

In T420 the terminal device 100 sends a token request to the printer 10. In the present case, only when the printer 10 receives the physical authentication being performed by the user, the printer 10 generates the token. Due to this, at the time of T420 where the printer 10 has not received the physical authentication, the token is not generated. Due to this, the printer 10 does not send a token to the terminal device 100.

In T430, the user performs the physical authentication on the printer 10. Due to this, in T432, the printer 10 generates the token tk2.

In T440, the terminal device 100 sends the token request to the printer 10, and in T442 receives the token tk2 from the printer 10 (YES to S252). The following T444, T450 to T456 are respectively the same as T334, T340 to T346 in FIG. 12. As such, the subscription to the subscription service by the user is completed.

### Effects of Cases A, B

The time required for the token to be received from the printer 10 without the printer 10 receiving the physical authentication after the instruction screen SC30 has been displayed in Case A of FIG. 12 is shorter than the time required for the token to be received from the printer 10 in response to the printer 10 receiving the physical authentication after the instruction screen SC30 has been displayed in Case B in FIG. 13. Accordingly, the displaying of the instruction screen SC30 can be suitably limited.

### Effects of Present Embodiment

According to the above configuration, the app 142 of the terminal device 100 displays the first password setting screen SC6 (see FIG. 3) on the display 114 in the case where the MIB value information includes the MIB value “Not Started” (NO to S22 in FIG. 3) (S30). According to such configuration, the user simply needs to input the update password in the update password input area 320, and he/she does not need to input the initial password. Accordingly, user convenience can be improved.

The terminal device 100 receives the response signal from the printer 10 in the case where the terminal device 100 receives the subscription operation. In the case where the response signal includes the failure information (NO to S222 in FIG. 9), the terminal device 100 displays the instruction screen SC30 (see FIG. 10) (S250). Contrary to this, in the case where the response signal includes the authentication success information (YES to S222), the terminal device 100 limits the displaying of the instruction screen SC30 (S230 to S234). According to such configuration, the displaying of the instruction screen SC30 is limited according to the information included in the response signal. Accordingly, user convenience can be improved.

### Correspondence Relationships

The printer 10 is an example for “image processing device”. The subscription service is an example for “service”. The response signal is an example for “update information”. The response signal including the failure information is an example for “first update information”. The volatile memory 134 of the terminal device 199 is an example for “memory”. The password “fea198” is an example for “specific password” and “update password”. The second request signal is an example for “information request”. The response signal of S142 is an example for “first update information”. The first password setting screen SC6 of FIG. 3 is an example for “password setting screen”. The update password input area 320 is an example for “password input area”. The token is an example for “predetermined information”.

S220 in FIG. 9 is an example for process realized by “acquire update information related to an update of an initial password”. S230 to S234 and S254 in FIG. 9 are an example for processes realized by “display on a display of the terminal device an instruction screen”.

### Second Embodiment

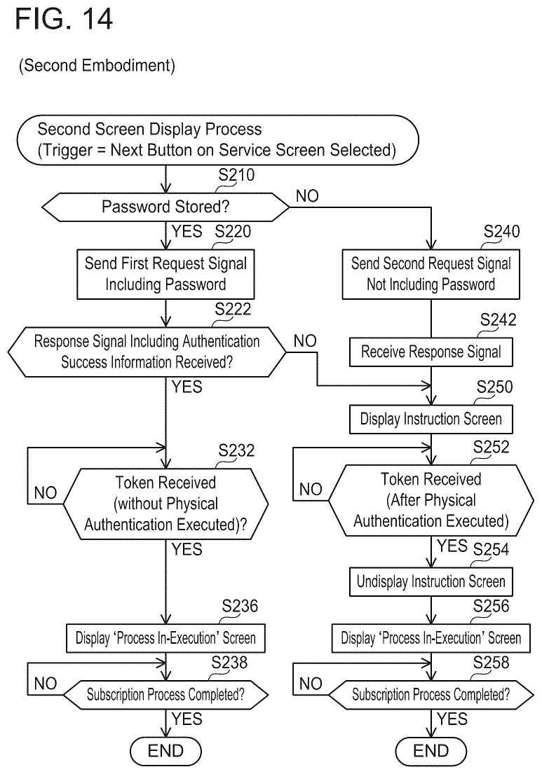

A second embodiment will be described. In the second embodiment, the app 142 of the terminal device 100 executes a second screen display process of FIG. 14 instead of the second screen display process of FIG. 9.

### Second Screen Display Process; FIG. 14

With reference to FIG. 14, the second screen display process of the present embodiment will be described. Here, processes same between the embodiments will be given the same step number and its description may be omitted.

In S222, the app 142 determines whether the app 142 has received the response signal including the authentication success information from the printer 10. In a case where the app 142 receives the response signal including the authentication success information from the printer 10 (YES to S222), the app 142 proceeds to S232. Contrary to this, in a case where the app 142 does not receive the response signal including the authentication success information from the printer 10 (NO to S222), the app 142 proceeds to S250.

In S232, the app 142 monitors receipt of a token from the printer 10. In a case where the app 142 receives the token from the printer 10, the app 142 determines YES to S232, and proceeds to S236. As such, in the present embodiment, in the case where YES is determined to S222, the instruction screen SC30 (see FIG. 10) is not displayed. According to such configuration, the displaying of the instruction screen SC30 is limited according to the information received from the printer 10. Accordingly, user convenience can be improved.

(First Modification) Although the server 200 is a physical server in the above embodiments, the server 200 is not limited to a physical server, but may be a virtual server or virtual machine on a cloud. That is, the vendor may not prepare hardware of the server 200 by themselves, but may implement an environment provided by an external cloud computing service. In this case, the vendor may prepare a program (i.e., software) for the server 200, and have the program introduced in the above environment to realize the server 200. In another modification, the server 200 may be installed on the Internet 6 by an entity different from the vendor.

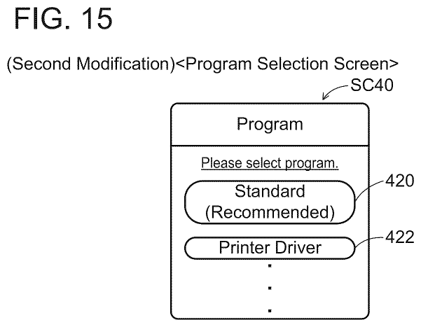

(Second Modification) When the terminal device 100 is a desktop PC or a laptop PC, in the case where YES is determined to S20 in FIG. 3, the case where YES is determined to S82 in FIG. 4, and after S110, the app 142 of the terminal device 100 displays a program selection screen SC40 (see FIG. 15) on the display 114. As illustrated in FIG. 15, the program selection screen SC40 includes program selection buttons 420, 422. The program selection buttons 420, 422 are buttons for selecting a program to be installed on the terminal device 100. Thereafter, when the installment of the program on the terminal device 100 completes, the app 142 proceeds to S90 in FIG. 4.

According to the above configuration, in the case where YES is determined to S20 in FIG. 3, the first password setting screen SC6 and the terminal-side initial setup screen SC8 (see FIG. 5) are not displayed on the display 114. Accordingly, a screen which is not useful for the user can be suppressed from being displayed on the display 114 and also a suitable screen can be displayed on the display 114.

In the case where YES is determined to S70 in FIG. 4, the terminal-side initial setup screen SC8 (see FIG. 5) is not displayed on the display 114. Accordingly, a screen which is not useful for the user can be suppressed from being displayed on the display 114 and also a suitable screen can be displayed on the display 114.

(Third Modification) The app 142 of the terminal device 100 may execute the following processes instead of S210 to S222, S240, and S242 in the second screen display process of FIG. 9. The app 142 sends the printer 10 an inquiry signal for inquiring whether the initial password 42 necessary for accessing the printer 10 has been updated. In a case where the printer 10 receives the inquiry signal from the terminal device 100 and the initial password 42 has not been updated, the printer 10 sends the terminal device 100 first answer information indicating that the initial password 42 has not been updated. Contrary to this, in a case where the printer 10 receives the inquiry signal from the terminal device 100 and the initial password 42 has been updated, the printer 10 sends the terminal device 100 second answer information indicating that the initial password 42 has been updated.

In a case where the app 142 receives the first answer information from the printer 10, the app 142 executes the sequence of processes from S250, whereas in the case where the app 142 receives the second answer information from the printer 10, the app 142 executes the sequence of processes from S230. In the present modification, the answer information, the first answer information, and the second answer information are respectively examples of “update information”, “first update information” and “second update information”.

(Fourth Modification) The app 142 of the terminal device 100 may execute the following processes instead of S210 to S222, S240, and S242 in the second screen display process of FIG. 9. In the present modification, the app 142 acquires password information indicating whether a password is stored in the volatile memory 134 or not. In a case where the password information is first password information indicating that a password is not stored in the volatile memory 134, the app 142 executes the sequence of processes from S250. Contrary to this, in a case where the password information is the second password information indicating that a password is stored in the volatile memory 134, the app 142 executes the sequence of processes from S230. In the present modification, the password information, the first password information, and the second password information are examples for “update information”, “first update information” and “second update information”, respectively.

(Fifth Modification) In S76, the app 142 of the terminal device 100 may store an update password in the non-volatile memory 136. In the present modification, in a case where a predetermined time (e.g., one hour) lapses after the update password is stored in the non-volatile memory 136, the app 142 may delete the update password from the non-volatile memory 136.

(Sixth Modification) After the app 142 of the terminal device 100 has displayed the instruction screen SC30 (see FIG. 10) on the display 114, the app 142 may send the printer 10 screen display information indicating that the app 142 displayed the instruction screen SC30 on the display 114. In the present modification, the app 142 monitors receipt of a stopping instruction for instructing to stop displaying the instruction screen SC30 from the printer 10 in S232 and S252 in FIG. 9. Then, the app 142 stops displaying the instruction screen SC30 in the case where the app 142 receives the stopping instruction from the printer 10 (S234, S254). Here, in a case where the printer 10 receives the screen display information from the terminal device 100 and also has already sent a response signal including the authentication success information, the printer 10 sends the stopping instruction to the terminal device 100 without receiving the physical authentication from the user. Contrary to this, in a case where the printer 10 receives the screen display information from the terminal device 100 and has already sent a response signal including the failure information, the printer 10 sends the terminal device 100 a stopping instruction for instructing to stop displaying the instruction screen SC30 after the printer 10 has received the physical authentication from the user. In the present modification, the stopping instruction is an example of “predetermined information”.

(Seventh Modification) The app 142 of the terminal device 100 may restrict the displaying of the instruction screen SC30 by voluntarily controlling operations of the display 114 so that the time for which the instruction screen SC30 is displayed in the case of YES to S222 in FIG. 9 is shorter than the time for which the instruction screen SC30 is displayed in the case of NO to S222. In the present modification, “receive the predetermined information” may be omitted.

(Eighth Modification) In each of the above embodiments, the processes of FIGS. 2 to 15 are realized by software (e.g., programs 40, 140, 142, 240), but at least one of these processes may be realized by hardware such as a logic circuitry.

What is claimed is:

1. A non-transitory computer-readable recording medium storing computer-readable instructions for a terminal device comprising a processor,
wherein the computer-readable instructions, when executed by the processor, cause the terminal device to:
receive a subscription operation for subscribing to a service related to an image processing device, the image processing device being configured to communicate with the terminal device;
in a case where the subscription operation is received, acquire update information related to an update of an initial password, the initial password being necessary to access the image processing device and being prestored in the image processing device; and
in a case where the acquired update information is first update information, display on a display of the terminal device an instruction screen for instructing a user to execute an authentication operation on the image processing device, wherein in a case where the acquired update information is second update information different from the first update information, displaying of the instruction screen is limited.

2. The non-transitory computer-readable recording medium according to claim 1, wherein the terminal device further comprises a memory,
wherein in a case where an update password is stored in the memory and the update password is stored in the image processing device, the first update information is acquired from the image processing device, the update password being a password with which the initial password is replaced, the first update information indicating that password authentication is successful, and
in a case where the update password is not stored in the memory or the update password is not stored in the image processing device, the second update information is acquired from the image processing device, the second update information indicating that the password authentication is not successful.

3. The non-transitory computer-readable recording medium according to claim 1, wherein the terminal device further comprises a memory,
wherein the computer-readable instructions, when executed by the processor, further cause the terminal device to:
in a case where a specific password is stored in the memory, send the specific password to the image processing device,
wherein in a case where the specific password has been sent to the image processing device and the specific password and an update password do not match, the first update information indicating that the specific password and the update password do not match is acquired from the image processing device, the update password being a password with which the initial password is replaced and stored in the image processing device, and
in a case where the specific password has been sent to the image processing device and the specific password and the update password match, the second update information indicating that the specific password and the update password match is acquired from the image processing device.

4. The non-transitory computer-readable recording medium according to claim 3, wherein the computer-readable instructions, when executed by the processor, further cause the terminal device to:
in a case where the specific password is not stored in the memory, send an information request not including the specific password to the image processing device,
wherein in a case where the information request is sent to the image processing device, the first update information which is a response to the information request is further acquired from the image processing device.

5. The non-transitory computer-readable recording medium according to claim 3, wherein the memory is a volatile memory.

6. The non-transitory computer-readable recording medium according to claim 3, wherein the computer-readable instructions, when executed by the processor, further cause the terminal device to:
display, on the display, a password setting screen including a password input area for inputting the update password,
in a case where an operation for inputting the update password in the password input area is received, send the update password to the image processing device;
in the case where the operation for inputting the update password in the password input area is received, store the update password as the specific password in the memory;
after the update password has been sent to the image processing device, execute an initial setup process related to an initial setup of the image processing device; and
in a case where the initial setup process is completed, display, on the display, a service screen corresponding to a service related to the image processing device,
wherein in a case where the subscription operation is received while the service screen is displayed on the display, the specific password in the memory is sent to the image processing device.

7. The non-transitory computer-readable recording medium according to claim 1, wherein the image processing device is configured to:
in a case where the first update information is sent to the terminal device, send predetermined information to the terminal device after the authentication operation on the image processing device has been received, and
in a case where the second update information is sent to the terminal device, send the predetermined information to the terminal device without receiving the authentication operation on the image processing device,
wherein the computer-readable instructions, when executed by the processor, further cause the terminal device to:
receive the predetermined information from the image processing device,
wherein in a case where the first update information is received from the image processing device, and the predetermined information is received from the image processing device in response to the image processing device receiving the authentication operation after the instruction screen has been displayed on the display, displaying the instruction screen is stopped, and
in a case where the second update information is received from the image processing device, and the predetermined information is received from the image processing device without the image processing device receiving the authentication operation after the instruction screen has been displayed on the display, restricting displaying of the instruction screen by stopping the displaying of the instruction screen.

8. The non-transitory computer-readable recording medium according to claim 7, wherein the predetermined information is a token generated by the image processing device and used in communication between the image processing device and the terminal device.

9. The non-transitory computer-readable recording medium according to claim 1, wherein in a case where the update information is the first update information, the instruction screen is not displayed.

10. The non-transitory computer-readable recording medium according to claim 1, wherein the service includes an automatic ordering service of automatically ordering a consumable article of the image processing device.

11. A terminal device comprising:
a display; and
a controller configured to:
receive a subscription operation for subscribing to a service related to an image processing device, the image processing device being configured to communicate with the terminal device;
in a case where the subscription operation is received, acquire update information related to an update of an initial password, the initial password being necessary to access the image processing device and being prestored in the image processing device; and
in a case where the acquired update information is first update information, display on the display an instruction screen for instructing a user to execute an authentication operation on the image processing device, wherein in a case where the acquired update information is second update information different from the first update information, displaying of the instruction screen is limited.

12. A method for controlling a terminal device, the method comprising:
receiving a subscription operation for subscribing to a service related to an image processing device, the image processing device being configured to communicate with the terminal device;
in a case where the subscription operation is received, acquiring update information related to an update of an initial password, the initial password being necessary to access the image processing device and being prestored in the image processing device; and
in a case where the acquired update information is first update information, displaying on a display of the terminal device an instruction screen for instructing a user to execute an authentication operation on the image processing device, wherein in a case where the acquired update information is second update information different from the first update information, displaying of the instruction screen is limited.

13. The method according to claim 12, wherein in a case where an update password is stored in a memory of the terminal device and the update password is stored in the image processing device, the first update information is acquired from the image processing device, the update password being a password with which the initial password is replaced, the first update information indicating that password authentication is successful, and
in a case where the update password is not stored in the memory or the update password is not stored in the image processing device, the second update information is acquired from the image processing device, the second update information indicating that the password authentication is not successful.

14. The method according to claim 12, further comprising:
in a case where a specific password is stored in a memory of the terminal device, sending the specific password to the image processing device,
wherein in a case where the specific password has been sent to the image processing device and the specific password and an update password do not match, the first update information indicating that the specific password and the update password do not match is acquired from the image processing device, the update password being a password with which the initial password is replaced and stored in the image processing device, and
in a case where the specific password has been sent to the image processing device and the specific password and the update password match, the second update information indicating that the specific password and the update password match is acquired from the image processing device.

15. The method according to claim 14, further comprising
in a case where the specific password is not stored in the memory, sending an information request not including the specific password to the image processing device,
wherein in a case where the information request is sent to the image processing device, the first update information which is a response to the information request is further acquired from the image processing device.

16. The method according to claim 14, wherein the memory is a volatile memory.

17. The method according to claim 14, further comprising:
displaying, on the display, a password setting screen including a password input area for inputting the update password,
in a case where an operation for inputting the update password in the password input area is received, sending the update password to the image processing device;
in the case where the operation for inputting the update password in the password input area is received, storing the update password as the specific password in the memory;
after the update password has been sent to the image processing device, executing an initial setup process related to an initial setup of the image processing device; and
in a case where the initial setup process is completed, displaying, on the display, a service screen corresponding to a service related to the image processing device),
wherein in a case where the subscription operation is received while the service screen is displayed on the display, the specific password in the memory is sent to the image processing device.

18. The method according to claim 12, wherein the image processing device is configured to:
in a case where the first update information is sent to the terminal device, send predetermined information to the terminal device after the authentication operation on the image processing device has been received, and
in a case where the second update information is sent to the terminal device, send the predetermined information to the terminal device without receiving the authentication operation on the image processing device,
wherein the method further comprises:
receiving the predetermined information from the image processing device,
wherein in a case where the first update information is received from the image processing device, and the predetermined information is received from the image processing device in response to the image processing device receiving the authentication operation after the instruction screen has been displayed on the display, displaying the instruction screen is stopped, and
in a case where the second update information is received from the image processing device, and the predetermined information is received from the image processing device without the image processing device receiving the authentication operation after the instruction screen has been displayed on the display, restricting displaying of the instruction screen by stopping the displaying of the instruction screen.

19. The method according to claim 18, wherein the predetermined information is a token generated by the image processing device and used in communication between the image processing device and the terminal device.

20. The method according to claim 12, wherein in a case where the update information is the first update information, the instruction screen is not displayed.

21. The method according to claim 12, wherein the service includes an automatic ordering service of automatically ordering a consumable article of the image processing device.
